(19) United States
(12) Patent Application Publication
(10) Pub. No.: US 2021/0164533 A1
(43) Pub. Date: Jun. 3, 2021

(54) VIBRATION DAMPER WITH ADJUSTABLE DAMPING FORCE

(71) Applicant: ZF FRIEDRICHSHAFEN AG, Friedrichshafen (DE)

(72) Inventors: Bernd ZEISSNER, Volkach (DE); Stefan SCHMITT, Gochsheim (DE); Thomas MANGER, Wasserlosen (DE)

(21) Appl. No.: 16/770,174

(22) PCT Filed: Nov. 7, 2018
(86) PCT No.: PCT/EP2018/080419

§ 371 Date: Jun. 5, 2020

(30) Foreign Application Priority Data
Dec. 8, 2017 (DE) 10 2017 222 232.8

(51) Int. Cl. F16F 9/32

(52) U.S. Cl. CPC F16F 9/325; F16F 9/3257

(57) ABSTRACT

A vibration damper with adjustable damping force, having an inner cylinder, which has a working chamber and a flow connection to a damping valve device situated outside forming an outer cylinder. The flow connection is made in a component separate from the inner cylinder, and the separate component is formed by an adapter sleeve, which forms a part of the working chamber and has a connection piece to the damping valve device.

### CROSS REFERENCE TO RELATED APPLICATIONS

This is a U.S. national stage of Application No. PCT/EP2018/080419 filed Nov. 7, 2018. Priority is claimed on German Application No. DE 10 2017 222 232.8 filed Dec. 8, 2017 the content of which is incorporated herein by reference.

### BACKGROUND OF THE INVENTION

### 1. Field of the Invention

The invention relates to a vibration damper with an adjustable damping force.

### 2. Description of Related Art

In a vibration damper with an adjustable damping valve device arranged at an outer side on an outer cylinder, there is often a problem of structural space as a result of an associated large cross section in a region of the damping valve device. With a conventional construction type, the vibration damper has a pipe socket via which the damping valve device is connected to the outer cylinder.

DE 34 18 262 A1 sets out, for example, in its FIG. 7, the problem of the radial structural space requirement. In order to mitigate the structural space requirement, a base is used for the outer cylinder, which already has a connection and channel geometry for the adjustable damping valve device. The outer cylinder is thereby extended. The disadvantage of this construction is an introduction of force into the connection region for the damping valve device.

FIG. 1 of DE 34 18 262 A1 shows that with smaller cylinder diameters a radial expansion is required in order to be able to use this special base.

### SUMMARY OF THE INVENTION

An object of one aspect of the present invention is a vibration damper with an external damping valve device, which has a small structural spatial requirement in a radial direction with respect to the installation location of the vibration damper.

An object of one aspect of the present invention is a separate component is formed by an adapter sleeve that forms a portion of the working chamber and which has a connection piece with respect to the damping valve device.

With the use of a separate adapter sleeve, the configuration of the valve connection is independent of the diameter and the wall thickness of the inner cylinder. There is thereby produced a significantly larger construction play which can be used for a reduction of the radial expansion of the vibration damper.

In one aspect of the present invention, the inner cylinder is axially supported by the adapter sleeve inside the vibration damper. Consequently, no additional radial fixing of the adapter sleeve is required. The radial guiding is carried out via the axial connection portions of the adapter sleeve.

For example, the adapter sleeve may be supported on a base valve member. The base valve member is retained and centered in a manner known per se on the base of the outer cylinder so that this centering also acts on the adapter sleeve.

Alternatively, the adapter sleeve may also be supported on a piston rod guide which generally has a guiding attachment for the inner cylinder and then available for the adapter sleeve.

According to of one aspect of the present invention, an outer covering face of the adapter sleeve has a sliding guide for the connection piece. Theoretically, the adapter sleeve and the connection piece could be produced in one piece. With the sliding guide, however, position imprecisions of the components involved may be compensated for within the vibration damper.

With regard to a maximum reduction of the radial projection of the damping valve device, the adapter sleeve has a receiving member for a transfer connection piece of the damping valve device. In comparison with an intermediate pipe with a pipe socket as a carrier of a fluid connection between a working chamber and the damping valve device, the receiving member makes it possible for the connection piece of the adapter sleeve to be able to have dimensions which are extremely short.

In another advantageous embodiment, the spacing of a base of the receiving member from a longitudinal axis of the inner cylinder is smaller than an outer radius of the inner cylinder. The damping valve device can thereby be introduced radially more deeply into the vibration damper than a wall of the inner cylinder would allow.

In order to be independent of the orientation of the adapter sleeve inside the vibration damper during assembly, the receiving member is constructed as an annular groove.

To produce the flow connection between the working chamber and the damping valve device in a simple manner, the annular groove is connected to the working chamber by means of at least one connection opening.

Advantageously, the adapter sleeve comprises at least one separate connection ring which fixes the adapter sleeve to the working chamber. The adapter sleeve simplifies the axial connection of the adapter sleeve to the axially adjacent component.

To be able to reproduce a wider size range with a minimum number of connection rings, the adapter sleeve has at the end side a step-like connection profile. Each step represents a connection diameter from the construction kit of the connection components, for example, inner cylinder, piston rod guide or base valve member.

There may also be provision for the adapter sleeve to be configured in an axially divided manner. This construction type can be assembled in a particularly simple manner with the connection piece.

To keep the individual component costs low, two adapter sleeve portions are configured as identical components. No installation positions must be complied with since there is necessarily a symmetry for the dividing joint of the adapter sleeve.

To be better able to absorb any transverse forces, the two adapter sleeve portions are secured against rotation by at least one positive-locking connection. Another advantage is that, when the adapter sleeve portions have the radial connection openings and they are located in the axial dividing joint, they always move into abutment in an optimum manner with the end faces thereof.

Another advantageous feature is that at least one annular seal is arranged in an annular groove between a pipe piece and the adapter sleeve, wherein one groove side wall is formed by the adapter sleeve and one groove side wall is formed by the pipe piece. The adapter sleeve portions can then be produced without any cutting post-processing operation since there are no undercuts.

### BRIEF DESCRIPTION OF THE DRAWINGS

The invention is now intended to be explained in greater detail with reference to the following description of the Figures.

In the drawings:

FIG. 1 is a longitudinal section of the vibration damper;

FIG. 2 is a detailed illustration of the adapter sleeve according to FIG. 1;

FIG. 3 is an axially divided adapter sleeve;

FIGS. 4 and 5 show a single-piece adapter sleeve; and

FIG. 6 shows an adapter sleeve in combination with a piston rod guide.

### DETAILED DESCRIPTION OF THE PRESENTLY PREFERRED EMBODIMENTS

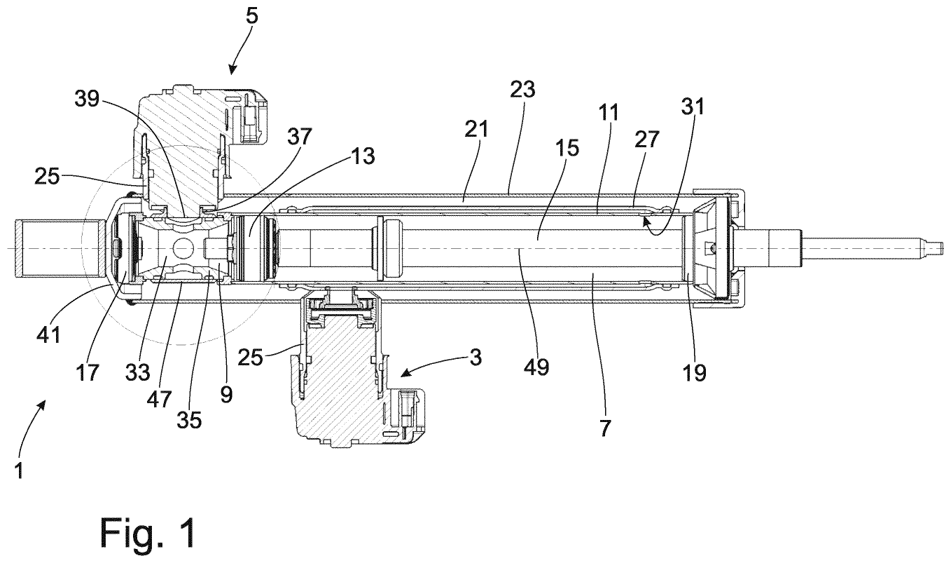

FIG. 1 shows a vibration damper 1 with adjustable damping force in section, wherein details of a damping valve device 3, 5 have been omitted since the configuration of the damping valve device 3, 5 has no influence on the invention. For example, the vibration damper 1 has two separately adjustable damping valve devices 3, 5 which in this embodiment for a working movement are connected in each case to working chambers 7, 9 in an inner cylinder 11. The inner cylinder 11 is subdivided by a piston 13 on an axially movable piston rod 15 into a piston-rod-side working chamber 7 and a working chamber 9 remote from the piston rod which are both completely filled with damping medium. At the end side, a base valve member 17 and a piston rod guide 19 close the two working chambers 7, 9.

The damping medium displaced during a piston rod movement is received by an annular compensation space 21 between the inner cylinder 11 and an outer cylinder 23. The compensation space 21 is filled via the discharge side of the two damping valve devices 3, 5. A return flow from the compensation space 21 is carried out via the base valve member 17 into the working chamber 9 remote from the piston rod.

The two damping valve devices 3, 5 are arranged outside the outer cylinder 23 and connected via a welded pipe socket 25 to the outer cylinder 23.

A first damping valve device 3 is subjected to flow via an intermediate pipe 27 which partially surrounds the inner cylinder 11 and which consequently forms a fluid connection 29 and which is connected to the piston-rod-side working chamber 7 via a fluid connection 31 in the wall of the inner cylinder 11. Depending on the energization of a coil within the damping valve device 3, the damping force is changed. With regard to structural details, reference may be made by way of example to DE 10 2013 209 928 A1. In this embodiment, it is assumed that both damping valve devices 3, 5 have only a single throughflow direction.

The second damping valve device 5 is connected via a flow connection 33 to the working chamber 9 remote from the piston rod. The flow connection 33 is formed by an adapter sleeve 35, which is open at the end side with respect to the working chamber 9 remote from the piston rod and which consequently also constitutes a component of this working chamber. The adapter sleeve 35 constitutes a separate component from the inner cylinder 11 and has a connection piece 37 with respect to a transfer connection piece 39 of the damping valve device 5.

The inner cylinder 11 is supported axially inside the vibration damper 1 via the adapter sleeve 35. In this instance, a base 41 of the outer cylinder 23, the base valve member 17, the adapter sleeve 35, the inner cylinder 11 and the piston rod guide 19 form a tension chain. In this embodiment, the adapter sleeve 35 is supported on the base valve member 17.

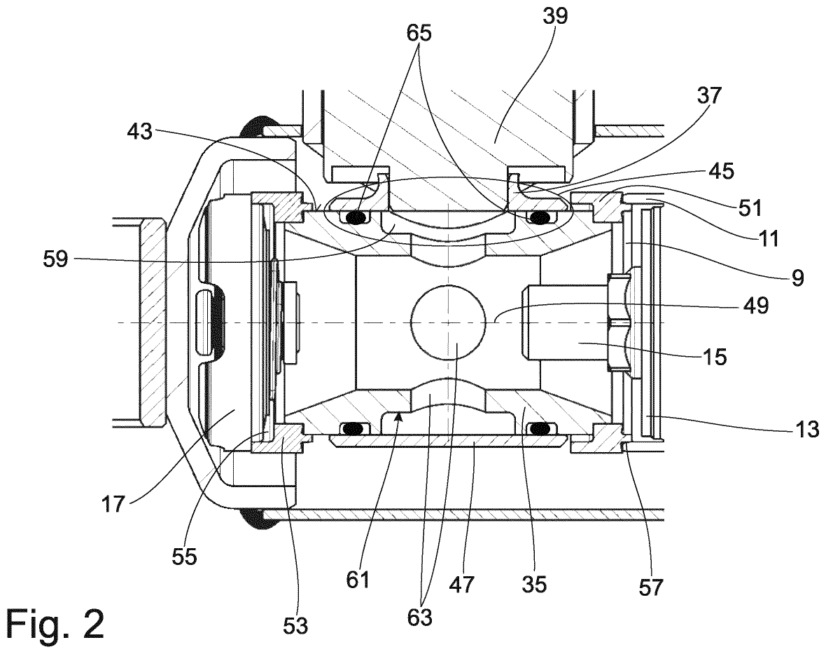

The adapter sleeve 35 has on an outer covering face 43 a sliding guide 45 for the connection piece 37 (see FIG. 2) which in turn is a constituent part of a pipe piece 47. The connection piece 37 extends radially with respect to a longitudinal axis 49 of the inner cylinder 11.

FIG. 2 shows a cut-out of the vibration damper according to FIG. 1 with a first embodiment of the adapter sleeve 35.

The adapter sleeve 35 comprises two separate connection rings 51, 53, via which the adapter sleeve 35 is fixed, on the one hand, to the base valve member 17 and, on the other hand, to the inner cylinder 11 and consequently to the working chamber 9 remote from the piston rod. The connection rings 51, 53 as part of the adapter sleeve 35 have a step-like connection profile 55, 57 relative to the base valve member 17 and the inner cylinder 11 in order as a standard component to be able to receive different cylinder diameters or base valve members. It is possible to use, for example, a base valve member 17 which differs in diameter from the diameter of the inner cylinder 11.

In this illustration, it can be seen that the adapter sleeve 35 has a receiving member 59 for the transfer connection piece 39 of the damping valve device 5. The receiving member 59 itself is configured as an annular groove. The spacing of a base 61 of the receiving member 59, that is to say, the annular groove base, with respect to the longitudinal axis 49 of the inner cylinder 11 is smaller than an outer radius of the inner cylinder 11. This results in a very large radial structural space advantage in comparison with an arrangement as is present in FIG. 1 in connection with the first damping valve device 3 and the intermediate pipe 27.

Via the annular groove or the receiving member 59 and a number of connection openings 63, the working chamber 9 remote from the piston rod is connected to the second damping valve device 5. During an introduction movement of the piston rod 15, the damper medium from the working chamber 9 remote from the piston rod is displaced via the adapter sleeve 35 through the connection openings 63 into the receiving member 59 and can flow further via the transfer connection piece 39 into the adjustable damping valve device 5.

During assembly, the adapter sleeve 35 is provided with a sealing set 65 of annular seals, which seal the connection piece 37 in the sliding guide 45. Subsequently, the pipe piece 47 is pushed with the connection piece 37 onto the adapter sleeve 35. Subsequently, the end-side connection rings 51, 53 are pressed on. The base valve member 17 and the adapter sleeve 35 in turn form an easy press-fit with the connection ring 53. The same applies to the connection between the inner cylinder 11 and the connection ring 51 so that this assembly unit is introduced into the outer cylinder 23 and fixed between the base 41 and the piston rod guide 19. For the assembly of the damping valve device 5, the connection piece 37 can be axially orientated via the pipe socket 25 which is still open in the outer cylinder 23 via a simple rod tool and in a precise manner in a peripheral direction so that there are no occurrences of torsion. As can be seen in the enlargement, the adapter sleeve 35 may have a substantially smaller outer radius than the inner cylinder 11 so that the radius difference is available as a structural space advantage.

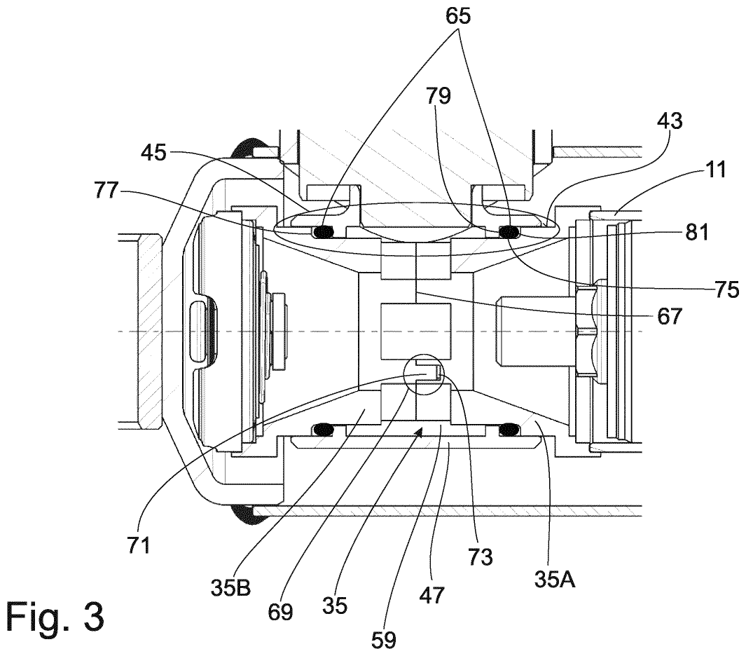

FIG. 3 shows a cut-out from a vibration damper 1 according to the structural principle of FIG. 1 with an axially divided adapter sleeve 35. A dividing joint 67 is located precisely at a center of the annular receiving member 59 so that two adapter sleeve portions 35A, 35B are constructed as identical components. The function of the separate connection rings 51, 53 from FIG. 2 is contained in the adapter sleeve portions 35A, 35B, that is to say, the outer covering face 43 in the region of the sliding guide 45 may have a significantly smaller radius than the outer radius of the inner cylinder 11.

Both adapter sleeve portions 35A, 35B are secured relative to each other against rotation by a positive-locking connection 69, schematically illustrated in this instance by an axial pin 71, which engages in a blind hole opening 73. A second positive-locking connection is located in a drawing plane rotated through 90°. The positive-locking connection 69 is intended to be understood to be only exemplary and other construction types may also be conceivable and advantageous.

The sealing set 65 according to FIG. 2 is also used in this instance, there however being no two-sided annular groove in the adapter sleeve portions 35A, 35B, but instead annular grooves 75, 77, in each case one groove side wall 79 is formed by the pipe piece 47 and one groove side wall 81 is formed by the adapter sleeve portions 35A, 35B. Via the sealing set 65 and the pretensions of the sealing set 65 by the pipe piece 47, the adapter sleeve portions 35A, 35B are held together for the period of the preassembly.

During preassembly, the annular seals of the sealing set 65 are each pushed onto the adapter sleeve portions 35A, 35B. Afterwards, the adapter sleeve portions 35A, 35B are introduced into the pipe piece 47 so that there is then a manageable structural unit which can be assembled between the base valve member 17 and the inner cylinder 11.

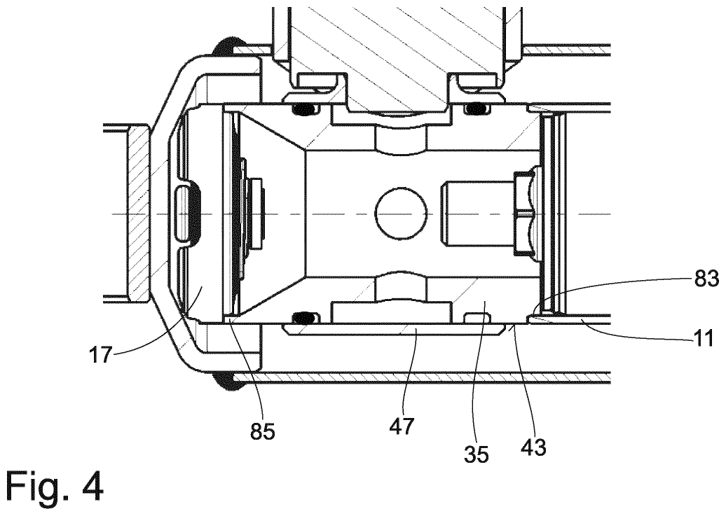

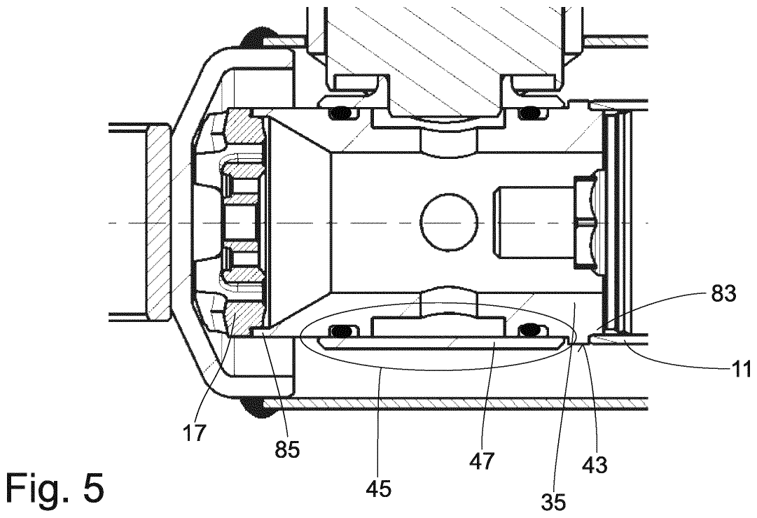

FIGS. 4 and 5 show a variant of the adapter sleeve 35 constructed in one piece and having a guiding attachment 83 for the inner cylinder 11 and a guiding web 85 for receiving the base valve member 17 at the end side. The diameter of the covering face 43 of the adapter sleeve 35 in FIG. 4 substantially corresponds to the outer diameter of the inner cylinder 11. The pipe piece 47 can thus be freely pushed over the inner cylinder 11 or over the base valve member 17 which is already mounted on the adapter sleeve 35.

In FIG. 5, there is an adapter sleeve 35 in which the sliding guide 45 for the pipe piece 47 is smaller than the outer diameter of the inner cylinder 11. To this end, the base valve member 17 has an outer diameter that corresponds to a maximum of the diameter of the sliding guide 45. Consequently, the pipe piece 47 can be pushed over the side of the base valve member 17 onto the adapter sleeve 35.

Even when the outer diameter of the covering face 43 is precisely as large as the outer diameter of the inner cylinder 11, a notable advantage is still achieved since with this adapter sleeve solution the wall thickness of an intermediate pipe and the radial extent of the fluid connection would be omitted.

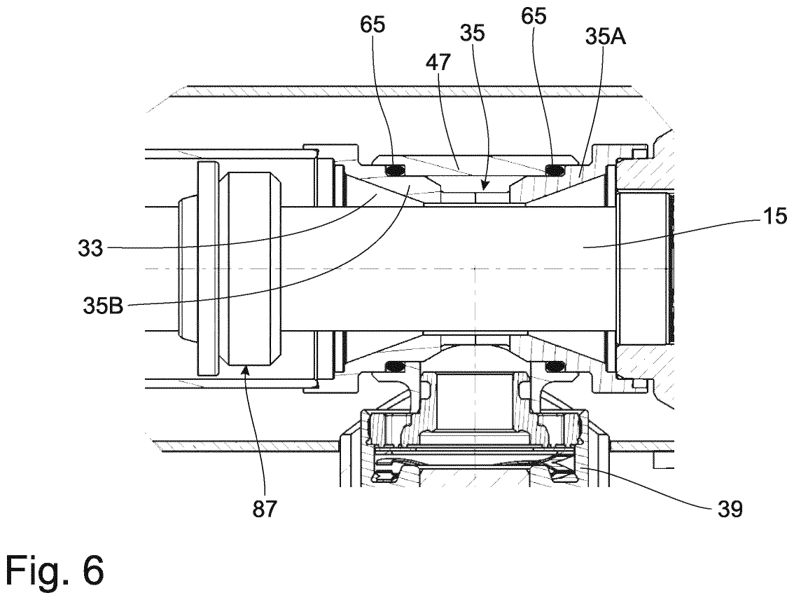

With FIG. 6, it is intended to be shown that the adapter sleeve 35 is not limited to use in the working chamber 9 remote from the piston rod. FIG. 6 shows a cut-out of a vibration damper according to FIG. 1, in which the adapter sleeve 35 corresponds by way of example to the principle of FIG. 3. In this instance, the adapter sleeve 35 is also suitable for also cooperating with a stop 87, which limits the travel path of the piston rod 15. The embodiment according to FIG. 6 can be combined both with an intermediate pipe known per se and fitted on the inner cylinder 11 or with a second adapter sleeve 35 in the working chamber 9 remote from the piston rod.

Furthermore, the adapter sleeve 35 contains according to FIG. 6 the additional modification that the entire cross section of the annular groove 59 is configured as a portion of the flow connection 33 between the adapter sleeve 35 and the transfer connection piece 39 inside the adapter sleeve 35. The pipe piece 42, with the exception of the shoulders for receiving the sealing set 65, can thereby have a constant inner diameter without any recesses. Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A vibration damper with an adjustable damping force, comprising:
a working chamber;
a flow connection;
a damping valve device;
an outer cylinder;
an inner cylinder with a working chamber having the flow connection to the damping valve device, which is arranged externally relative to the outer cylinder;
an adapter sleeve, which is separate from the inner cylinder, in which the flow connection is constructed at least in part, the adapter sleeve forms a portion of the working chamber and having a connection piece with respect to the damping valve device.

17. The vibration damper as claimed in claim 16, wherein the inner cylinder is axially supported by the adapter sleeve inside the vibration damper.

18. The vibration damper as claimed in claim 17, wherein the adapter sleeve is supported on a base valve member.

19. The vibration damper as claimed in claim 17, wherein the adapter sleeve is supported on a piston rod guide.

20. The vibration damper as claimed in claim 16, wherein an outer covering face of the adapter sleeve has a sliding guide for the connection piece.

21. The vibration damper as claimed in claim 16, wherein the adapter sleeve has a receiving member for a transfer connection piece of the damping valve device.

22. The vibration damper as claimed in claim 21, wherein a spacing of a base of the receiving member from a longitudinal axis of the inner cylinder is smaller than an outer radius of the inner cylinder.

23. The vibration damper as claimed in claim 21, wherein the receiving member is configured as an annular groove.

24. The vibration damper as claimed in claim 23, wherein the annular groove is connected to the working chamber by at least one connection opening.

25. The vibration damper as claimed in claim 16, wherein the adapter sleeve comprises at least one separate connection ring configured to fix the adapter sleeve to the working chamber.

26. The vibration damper as claimed in claim 25, wherein the adapter sleeve has, at an end side, a step-like connection profile.

27. The vibration damper as claimed in claim 16, wherein the adapter sleeve is axially divided.

28. The vibration damper as claimed in claim 27, wherein the adapter sleeve comprises two adapter sleeve portions that are configured as identical components.

29. The vibration damper as claimed in claim 27, wherein the adapter sleeve comprises two adapter sleeve portions that are secured against rotation by at least one positive-locking connection.

30. The vibration damper as claimed in claim 16,
wherein at least one annular seal is arranged in an annular groove between a pipe piece and the adapter sleeve, and
wherein one groove side wall is formed by the adapter sleeve and one groove side wall is formed by the pipe piece.
